(19) United States
(12) Patent Application Publication
(10) Pub. No.: US 2003/0158924 A1
(43) Pub. Date: Aug. 21, 2003

(54) System and method for measuring quality of service rendered via multiple communication channels

(76) Inventor: Ronald L. DeLegge, Skokie, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/051,635

(22) Filed: Jan. 18, 2002

(51) Int. Cl. G06F 15/173

(52) U.S. Cl. 709/223

(57) ABSTRACT

A system and a method are disclosed for determining/reporting performance for a service entity. The system and method include means for generating index values representing quality of rendered services for an industry or any other measured entity/group. The index values accessed by a comparison/reporting mechanism interfacing subscriber users to rendered indices. The service index permits evaluation of service performance rendered via multiple service channels, for multiple service factors, in multiple industry sectors using a single index value as the comparison/reporting mechanism. The system retrieves raw service transaction data from service provider entities and independent agencies. During retrieval, the system filters the raw service data according to, by way of example, data source, industry sector code, service channel code, and service factor code. The retrieved, filtered data is used to generate an aggregate index value according to an index definition including a component weighting scheme.

### FIELD OF INVENTION

The present invention generally relates to measuring service performance for a service operation within an organization. More particularly, the invention relates to methods and systems for carrying out index-based service rating/grading of services rendered by an organization through collecting, aggregating, and calculating service data, and using index values as a comparison/reporting mechanism. Examples of such services/channels are customer services rendered via a variety of channels such as telephone, email, and facsimile.

### BACKGROUND OF INVENTION

The ability to effectively and efficiently use service data, such as transaction duration or routing accuracy, in combination with external service data, such as customer satisfaction indicators, to determine service performance, has been hampered by an inability of a performance management system to successfully aggregate and integrate service information coming from multiple data sources. In typical performance measurement applications, the information available to a user corresponds to a service channel and service factor upon which a service transaction originates. If a user/subscriber to the performance management system attempts to evaluate service performance for a specific factor, such as transaction security, the reporting mechanism will separately indicate and report performance for each service channel and each service factor. The performance measures for each service channel/factor combination is disassociated from other service performance data. In the case where a relatively wide range of service channels and/or factors (“service areas”) are evaluated, the system subscriber potentially obtains performance information relating to particular service areas via distinct and separate reporting systems. The data gathered by these systems includes among other things, routing accuracy, transaction duration, transaction security, response times, response quality, and order processing.

A drawback of this approach is that service data originating from a particular reporting system is not easily associated with other service performance measures provided by other reporting systems. For example, a first type of service performance measurement data, such as transaction security via the telephone, coming from a first service performance reporting system, is not easily compared to associated service data, such as transaction duration via the telephone, originating from a second reporting system. Additionally, as the number of non-corresponding reporting systems is increased, so too does the complexity of the task of managing service data flow/presentation and reporting the performance data to interested parties. The inefficiency of this approach and the resulting problems are further accentuated as new service channels are added, and the size of the service organization increases. These inefficiencies necessitate an increase in the time of data analysis in support of service performance reporting. This, in turn increases the cost/effort to detect and remedy poor service quality either in general or with regard to particular service areas.

A further shortcoming of known service organization performance tracking systems is their focus on a single, or at best a very narrow, service area. For example, a known Internet service performance reporting mechanism monitors and reports only how fast a monitored Website downloads. The service performance reporting mechanism does not associate/integrate the Website download speed measure with other, complimentary service channels such as fax-based customer service. Furthermore, the Website download speed monitoring mechanism does not address other elements of customer service performance and quality such as: complaint resolution effectiveness, transaction security, transaction duration, response time, response quality, routing accuracy, service policies, and order processing.

Another known service performance measurement system acquires and combines performance information relating to a particular service center in a call center environment. This system is sometimes referred to as “benchmarking.” The system computes and presents service performance measures based upon: information call volume, call timing, number of abandoned calls, etc., with the purpose of comparing an organization's service performance versus another organization.

### SUMMARY OF THE INVENTION

The present invention addresses a need to associate service transaction data associated with multiple service channels and/or acquired from multiple reporting systems into one standardized reporting measure/mechanism. Rather than focus upon the satisfaction of a consumer with a product, the service index of the present invention addresses the quality of services (e.g., customer service) rendered by companies to consumers. The service index comprises, by way of example, components rendered from measured parameters such as duration of phone calls, delays in responses to email queries, etc.

The present invention facilitates determining service performance for a service organization by means of an index value-based reporting mechanism. Indexing involves combining performance measurement values from a variety of service transaction sources over potentially multiple channels to render a single aggregate service performance value that corresponds to a group of index constituents. Thereafter, individual service organizations can compare their individual service performance measures to the index value to gauge service performance. Indexing thus enables reporting service performance across multiple service channels for numerous factors, via one index value.

Index-based service performance measures permit simultaneous evaluation of multiple service channels, for multiple service factors, in multiple industry sectors while using a single value as the reporting mechanism. Examples of service channels include, but are not limited to, telephone, fax, Internet communications, voice recognition software systems, wireless applications, self-help applications, instant messaging, postal mail, and person-to-person communications. Examples of service factors include response time, response quality, routing accuracy, order processing accuracy/speed, product delivery, complaint resolution effectiveness, transaction security, transaction duration, customer satisfaction, independent service ratings, general reliability, and service policies. Moreover, the index value-based service performance measurement/reporting mechanism facilitates aggregation and integration of internally or externally generated service data.

### BRIEF DESCRIPTION OF DRAWINGS

The appended claims set forth the features of the present invention with particularity. The invention, together with its objects and advantages, may be best understood from the following detailed description taken in conjunction with the accompanying drawings of which:

FIG. 1 is high level block diagram depicting a system/computing environment embodying the present invention;

FIG. 2 is a block diagram further identifying functional elements built into the index aggregator of a system embodying the present invention;

FIG. 3 illustratively depicts an exemplary service performance data record received and processed by the system in accordance with an embodiment of the present invention;

FIG. 4 illustrates steps performed by the three primary functional elements of the index aggregator of a system embodying the present invention;

FIG. 5 is a block diagram illustratively depicting functional elements incorporated into a subscriber interface of the index aggregator;

FIG. 6 is a flowchart illustratively depicting exemplary steps associated with customization of processes that render service performance index values in accordance with an embodiment of the present invention; and

FIG. 7 illustratively depicts displayed output pertaining to a set of comparative service index values over time.

### DETAILED DESCRIPTION OF THE DRAWINGS

In accordance with an embodiment of the present invention an index aggregator system acquires service transaction quality information from multiple distinct sources. The quality of service information is obtained for a variety of service communication channels (e.g., call center, email, facsimile, etc.). The index aggregator system renders a set of pre-programmed indices and user-specified customized indices based upon the received quality of service information. The index aggregator system thereafter reports the indices in a variety of formats, including snapshot and histogram user interface views.

Quality of service transaction indices are composed of components representing transaction data from a variety of sources. Such sources include internal data sources that provide service transaction quality data acquired in conjunction with index building operations of the index aggregator system. Quality of service transaction information acquired specifically on behalf of the index aggregator system by a particular call center is an example of internal data. External data sources provide service transaction quality data acquired by third parties—and therefore is not specifically acquired on behalf of the index aggregator system. The external data, e.g., an industry benchmark, is potentially combined with index components rendered by internal data sources or even other external data sources to render indices. Thus, the present invention contemplates internal, external, and hybrid indices based upon the sources of quality of service transaction information.

In an exemplary embodiment, in addition to computing and presenting indices, the system determines/reports service performance for a subscriber by retrieving service performance data for a selected service organization/entity. A service performance index value is rendered for the selected entity based upon the service performance data relating to potentially many different service areas including multiple channels and factors, and supplied potentially from external measurement systems. In this example, the service performance index value represents a composite of service transaction data acquired by the system for the potentially multiple service areas.

In the exemplary embodiment, the system collects, aggregates, and stores internally and externally generated service performance data as a set of records in a database. The records include, by way of example, a source ID, a sector ID, a channel ID, and a factor ID. The index aggregator system selectively retrieves the service performance data records, and provides the data to a processing engine within the system to render a service performance index value. The processing engine renders for service channels and service factors of interest, a numerical value based on actual performance as measured by the retrieved service transaction records for an organization. The set of service channel/factor values are then passed to an index value generator. The set of service channel/factor values are utilized to generate an overall service performance index value for the organization. The service performance index value for the organization is then reported to the subscriber via a reporting interface that includes, for example, comparative index values for an industry or designated sectors of interest specified by the subscriber.

The user interface supports designation of a variety of indices reported by the system at the request of subscribers. The components (and associated weights) that make up a service performance index are editable by a subscriber. Calculated index values, comprising the means by which performance for service organizations is graded, are rendered by a reporting mechanism of the subscriber interface. The calculated index values are compared to more generalized industry or sector service performance index values rendered from a broader set of records maintained within the system's service transaction database.

Advantageously, the system and method of the present invention decrease data processing burden upon individuals by reporting service performance grades via index values that represent a composite score based upon a set of transactions executed via potentially multiple service channels and performance factors. As such, all scored service channels and service factors that contribute to an index value are incorporated within a reported index value. Individual transactions, factors and channels need not be individually considered by subscribers.

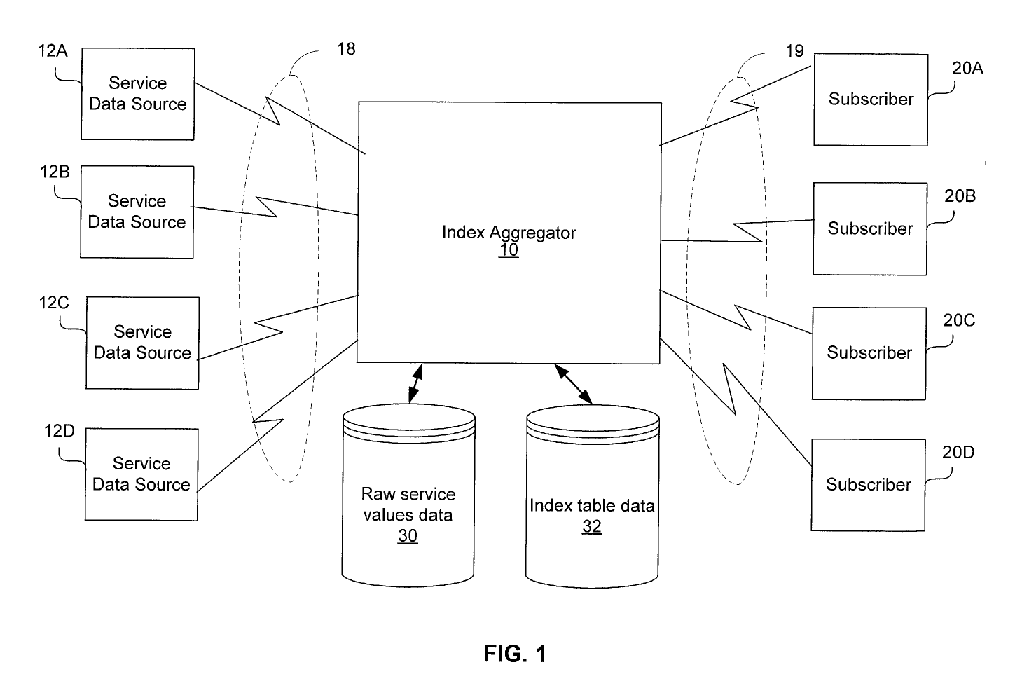

FIG. 1 illustrates an exemplary embodiment of a system embodying the present invention. The system includes an index aggregator 10. The index aggregator 10 includes a computer system including a processor and operating system as well as application software for carrying out the data interface and processing functionality described herein. The index aggregator 10 receives service performance data, in potentially a variety of formats and relating to a variety of channels and factors, from service data sources 12A, 12B, 12C, 12D via input links/interfaces 18. The input links/interfaces 18 include both local data access to disk drives installed upon the index aggregator 10, and non-local access supported by the Internet or a dial-up linkage to a remote performance data source computer. The service performance data includes raw service performance data that represents actual service transactions. An example of raw service performance data is transaction duration or transaction security for a particular service organization. The service performance data also includes compiled service performance information such as a customer satisfaction report or service rating by an independent agency. In an embodiment of the present invention, these two distinct types of service performance data (and potentially others) are combined to render a service performance index value for a service entity. A “service transaction” is a communication interaction between a provider of monitored services representing an index component (e.g., a service organization), and a service recipient (e.g., customer). A service transaction is an exchange or transfer of goods, services, data, or funds. An index component corresponds to, for example, a compiled set of monitored service instances executed by a service provider entity, and the service receptor is, by way of example, a customer, an employee, a supplier, or a business partner on the receiving end of service transactions.

The index aggregator 10 is linked to, and accesses quality of service transaction data stored within, a raw service values data store 30 that maintains service performance information received from the service data sources 12. In addition to actual service transaction data for individual service transaction the data store 30 also contains compiled service data of a variety of types that is transformed by the index aggregator 10 into particular service performance index component values. The index aggregator 10 is also linked to a index table data store 32 that maintains service performance index data calculated by the index aggregator 10. Index aggregator 10 reports calculated service performance data to subscribers 20A, 20B, 20C, 20D, via links/interfaces 19 that comprise for example, a variety of local and remote linkages to subscriber/users of the system for rendering service performance indices. As mentioned previously above service performance values are rendered via index values calculated from potentially multiple types of service performance data received in a variety of forms from the multiple service data sources 12A-D.

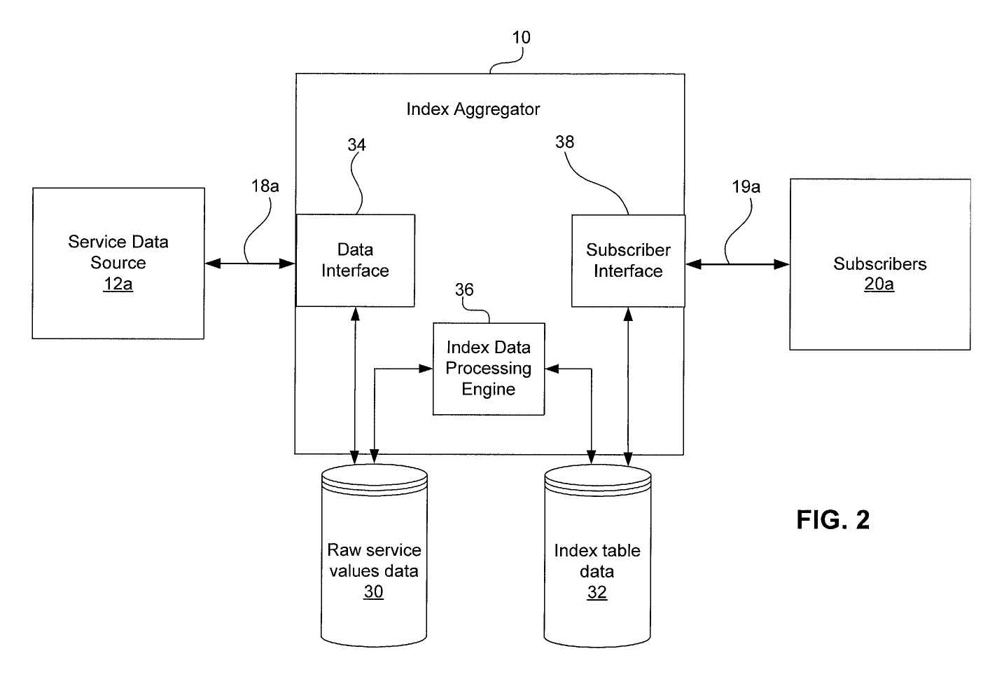

FIG. 2 illustratively depicts primary functional elements incorporated within the index aggregator 10. The embodiment depicts the communication link 18a through which service data source 12a transmits service performance data to a data interface 34 of the index aggregator 10. The data interface 34 includes sufficient message interpretation capabilities to direct different types of input data distinguished, for example, by tags to proper storage locations in the raw service values data store 30. Examples of such data types include actual transaction performance values from a service entity represented within an index component and compiled data from an independent agency that is incorporated with appropriate normalization and/or weighting into a calculated service performance index.

An index processing engine 36 retrieves raw service information from the database 30, aggregates data, assigns scores, calculates data, and deposits calculated index values in the index table database 32. In general, the index processing engine 36 is responsible for generating service index values that provide a measure of how a service branch of particular organization and/or a broader industry sector is performing. These calculated index values are then stored within the index table data store 32. Calculated index measures are composite values rendered from the service performance information (of many potential types) received by the index aggregator 10 and stored in the data store 30. In an embodiment of the present invention, certain pre-programmed standard service index definitions are augmented by a generalized index generation engine within the index processing engine 36. The generalized index generation engine takes custom index specifications from users via a subscriber interface and renders custom service index measures based upon information retrieved from the service value data store 30.

In addition to receiving and passing custom index requests to the index processing engine 36, the subscriber interface 38 retrieves data from the index table data store 32 in response to queries from, for example, the subscriber 20a communicatively linked to the index aggregator 10 via a network link 19a. In a particular embodiment of the present invention, the subscriber interface is rendered via a site on the Internet. The subscriber 20a accesses the subscriber interface 38 via an Internet browser executing on the subscriber 20a's computer and linked via an Internet service provider to the subscriber interface Web site. However, in alternative embodiments of the invention, the subscriber interface 36 comprises alternative communication links such as those supported by direct dial-up modem connections, local area networks, and corporate intranets. In general, the subscriber interface 36 routes service performance index data queries from the subscriber 20a to the index processing engine 36, and transfers responsive index data provided from either the index processing engine 36 or the index table data store 32 (in the case of pre-calculated standard indexes) to the subscriber 20a. Thus, the index aggregator 10 embodying the present invention insulates subscribers from massive, potentially complex analysis of input from a variety of source by rendering simple index values generated from a variety of service performance data types and calculated according to either standardized or customized index value rendering formulas.

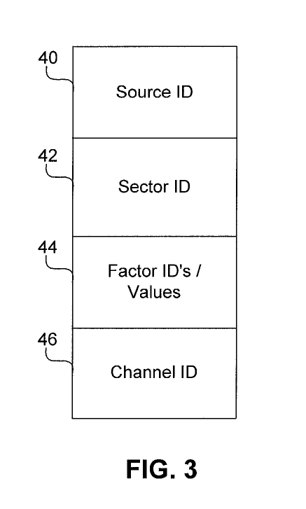

FIG. 3 illustrates exemplary information for service transaction data input collected by the index aggregator 10 and stored in the service value data store 30. A source ID 40 identifies the source of service transaction data, such as a particular index customer's service operation or a business partner that supplies data for a component of a service index. In general, the source ID 40 enables the index aggregator 10 to later match service transaction data retrieved from the raw service values data 30 with the source of that information. In an embodiment of the invention the identification includes further source differentiation information such as a particular service group or even employee of a service operation. The level of detail varies in accordance with particular service data sources and the capabilities of the index aggregator to provide varying levels of particularity in identifying service sub-units within an organization. Source ID 40 also identifies a service entity that executes a service transaction.

Depending on a point of origin identified in the source ID 40, the service data content is categorized as originating from an external or internal data source. For example, calculated service data by independent agencies aggregated by the index aggregator 10 is classified as external data from external sources, and may require further formatting or manipulation prior to use. On the other hand, raw service data, like routing accuracy, that is obtained and presented to the index aggregator 10 for purposes of establishing index is identified as internal data from an internal data source and generally does not require reformatting prior to storage or subsequent use by the index aggregator 10.

Continuing with the description of the exemplary input service data format utilized by the index aggregator 10, a sector ID 42 stores a value that identifies the industry sector code assigned to a supplier of service performance data. For example, service performance data from a healthcare facility is assigned a sector ID associated with healthcare organizations. In an embodiment of the invention, a service index is calculated for distinct sectors based upon input service performance data received for service organizations that make up components for that particular index. An insurance sector index, for example, is generated from service performance data including a sector identification identifying the insurance sector.

A factor IDs/values 44 stores paired data including identification of a particular type of measured service performance factor and a corresponding value assigned to a particular service transaction that gave rise to the input data. It is noted that the factor IDs/values 44 is capable of storing multiple sets of data for each record. Alternatively, each input record includes all potential factor IDs and a particular value's data type is implied by its position in the factor IDs/values 44 field. Examples of factor data types include, but are not limited to, transaction duration, transaction security, or order processing efficiency/speed.

A channel ID 46 stores a value identifying the service channel used by a service organization to communicate during a monitored service transaction with someone, such as, a customer or employee. Examples of channels include, without limitation: email, facsimile, telephone conversation, telephonic voice recognition systems, or a face-to-face engagement.

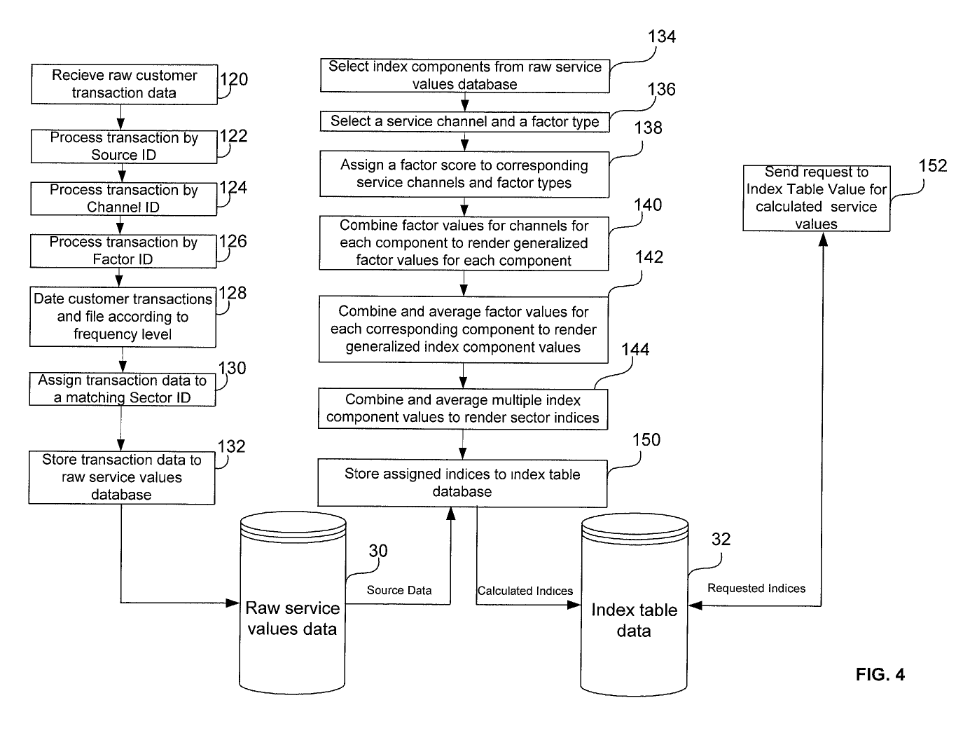

Turning now to FIG. 4 operations (steps) associated with the internal operations of three primary elements of the index aggregator 10 are illustratively depicted. The order and scope of these operations differs in accordance with various embodiments of the invention. However, in an embodiment of the invention, steps are taken to standardize and arrange the input data at the time it is received to reduce search time in response to requests to retrieve particular data types.

By way of example, during step 120 the data interface 34 receives raw transaction data from a variety of data sources. Such data is generally provided as a batch of transactions from a particular provider of service performance information. The data providers are not necessarily the same as the entity/organization that performed the service transaction.

After receiving the data, the data interface 34 generates (where necessary) and stores service transaction data records having fields corresponding to the fields identified hereinabove with reference to FIG. 3. During step 122 the data interface 34 processes data transactions for purposes of rendering a source ID 40 for each transaction. Thus, data for a particular service organization (or sub-entity thereof) is distinguishable from the transactions of other entities for who service performance is monitored. During step 124 the transaction data is further processed for storage by providing a value corresponding to the channel through which the service transaction occurred.

During step 126 the interface 34 generates factor types and corresponding values for each transaction. Such information may already exist for internal data providers. In the case of externally provided data the factors and corresponding values are generated according to data conversion/normalization algorithms implemented by the interface 34 to render normalized data according to an internal data scale used by the index aggregator 10 to evaluate all service transactions. By way of example, a service transaction tracked for the routing accuracy factor type, is identified and matched with its corresponding internal factor type.

During step 128 the data interface assigns dates to the records summarizing the service transactions in the data store 30. Furthermore, in an embodiment of the present invention where a set of transactions meeting a particular designated transaction filter are aggregated at the time of reception to render a composite score, a “frequency” value is generated for a set of grouped/averaged transactions (e.g., a particular service operation, a particular channel, etc.). As such, an appropriate weight is assignable to the grouped transaction values based upon the number of transactions when the grouped transactions are provided to calculate a component value within a composite index.

In an embodiment of the invention, during step 130 the data interface 34 assigns (if needed) a sector ID value to each transaction record. The sector ID value enables transactions in a particular area of commerce to be compiled and provided as an industry standard with which individual service operations can compare. For example, customer service transaction data for a credit card is assigned a sector ID value corresponding to a best matching business sector, in this case, the banking sector.

During step 132 the index aggregator 10 stores the data received and processed during the previous steps 120-130 in the raw service values data store 30. As noted previously above, the raw service transaction quality information stored in the data store 30 includes both internal and external information. Internal data, by way of example includes raw routing accuracy service data, collected by the index aggregator 10. The internal data generally follows the format depicted in FIG. 3. On the other hand, external service transaction quality data includes, for example, calculated customer satisfaction data, accumulated and processed by an independent service research organization. The external service transaction data is provided in a format differing from the general format of the internal data depicted in FIG. 3. Thus, in an embodiment of the invention, the raw service values data comprises multiple data structures including, for example, tables, files, directories, etc. for storing received data rendered in a variety of formats. It is further noted that the external data, in an embodiment, is stored directly into the data store 30 without performing the processing steps 122-130. In other instances, one or more of the processing steps 122-130 are bypassed.

With reference now to the processing engine 38, a sequence of steps are summarized that are performed by the processing engine 38 in an embodiment of the present invention to render indices based upon criteria supplied from a variety of sources (including subscribers). During step 134 the processing engine 38 establishes/selects index components from the raw service data database 30. Such components are identified by, for example, source IDs associated with particular service entities as well as generalized/composite external sources of service performance data compiled and rendered by, for example, a partner service quality auditing organization. The components of a particular index are specifiable by a variety of sources including pre-programmed index component lists (analogous to a stock index) including a set of components and their associated weights. Alternatively, components for a particular index are specified by a subscriber via a customization user interface described further herein below.

During step 136 the processing engine 38 establishes particular service performance data limitations for purposes of rendering an index according to a supplied criterion. Potential sources for criteria include, by way of example, pre-programmed index specifications and real-time subscriber-supplied specifications (via the subscriber interface 36). In an embodiment of the invention one or more service channels and/or factor types are identified during step 136 to be used as a data filter when selecting particular transaction data associated with index components previously selected during step 134. Service channels are coded under the channel ID 46 of FIG. 3. An example of such limited transaction record designations are service transaction records for the factor of transaction security over a Web service channel for designated index components for which detailed service transaction records have been stored in the data store 30.

Next, during step 138 the processing engine 38 generates a scaled factor score for each service channel and factor type combination specified during step 136, for each index component specified during step 134. The scores are based upon the values within the data store 30 for each component's service transactions. In the case of multiple transactions meeting a particular component/factor/channel filter, the scores are aggregated to render an average scaled score for the multiple transactions. For example a set of 27 transactions stored within the data store 30 designate a healthcare facility “M” index component, a “Web service” channel, and include a value for a “query response time” service factor. The processing engine calculates an average value from the 27 transactions (e.g., an average value of seven on a scale of one to ten). In some cases the raw values are provided according to a range differing from the range (e.g., one to ten) for reporting averages during step 138. In such cases, the values (e.g., minutes delay) are scaled (and possibly an offset is applied) to render a final scaled average for the responsive transaction values according to the designated reporting range.

During step 140 a first of three weighting/aggregation formulae is applied to the scaled factor/channel averages rendered for individual components during step 138 to render a factor score for each component. This step, in effect removes channel distinctions from the output rendered during step 138. By way of example, the processing engine 38 applies a weighting formula to the scaled scores to render aggregate scores for factor/component combinations for index components that are based upon accumulated service transactions. For illustrative purposes, in a simple case, assume that a single factor (e.g., customer query resolution time) is monitored across five distinct channels in a particular index, and each channel is given equal weight in a formula applied during step 140. Assume also that the scaled, averaged factor values for a particular component such as a healthcare facility equal 5, 9, 7, 7, and 7 for the five monitored service channels. The five distinct channel scores for the designated factor are added together (with equal weighting) to render a composite score of thirty-five for the service factor measured for the particular healthcare facility over the five service channels.

During step 142, a second weighting/aggregation formula is applied to the generalized factor scores rendered for components during step 140. Step 142, in effect, eliminates factor distinctions from the output rendered during step 140. The output of step 142 is a set of component-specific service performance values. In the case where only a single factor is selected during step 136 for building an index there is no need to aggregate values. However, the output of step 140 for the single measure factor is potentially scaled during step 142.

During step 144, a third weighting/aggregation formula is applied to the generalized component-specific service performance values rendered during step 142. Step 144, in effect, eliminates distinctions between various components by combining groups of individual component values rendered during step 142 according to a specified weighting and scaling scheme. In an embodiment of the invention, the components are weighted and combined according to sector classifications (e.g., health insurance, banking, Internet sales, etc.). In other embodiments of the invention indices comprise exclusively internal or external service values, or a combination of both. Furthermore, these components are capable of being weighted non-uniformly to emphasize certain components over others. For example, an internal service value, could overweight routing accuracy and underweight response times, by applying standard mathematical techniques that increase the percentage of influence routing accuracy has within an index.

In the case of sector-based indices a processing engine 38 matches index components to a designated relevant sector, and determines the sector index value during step 144 based upon a weighting and scaling formula applied to designated sector values. For example, to determine a banking sector service performance index value from five constituent banking institutions, the component value rendered during step 142 for each distinct institution is combined in accordance with a weighting/aggregation formula to render a representative service performance index value for the banking sector.

Thereafter, during step 150 the computed generalized indices are tagged for identification purposes (e.g., date, sector, index name, etc.) and stored in the index data store 32 for subsequent retrieval in response to queries such as those submitted to the index data store 32 via the subscriber interface 36 during step 152.

Having described a representative set of steps, or stages, executed by the processing engine 38 to render an index, it is noted that a number of variations upon the basic steps are potentially applied in accordance with alternative embodiments of the invention. For example a user or administrator, via the subscriber interface 36 (described further herein below), designates particular components of a particular index (including ones from differing sectors), different sets of factors, different sets of channels, as well as how the individual values are weighted when grouped with others to form components of an index or the index itself.

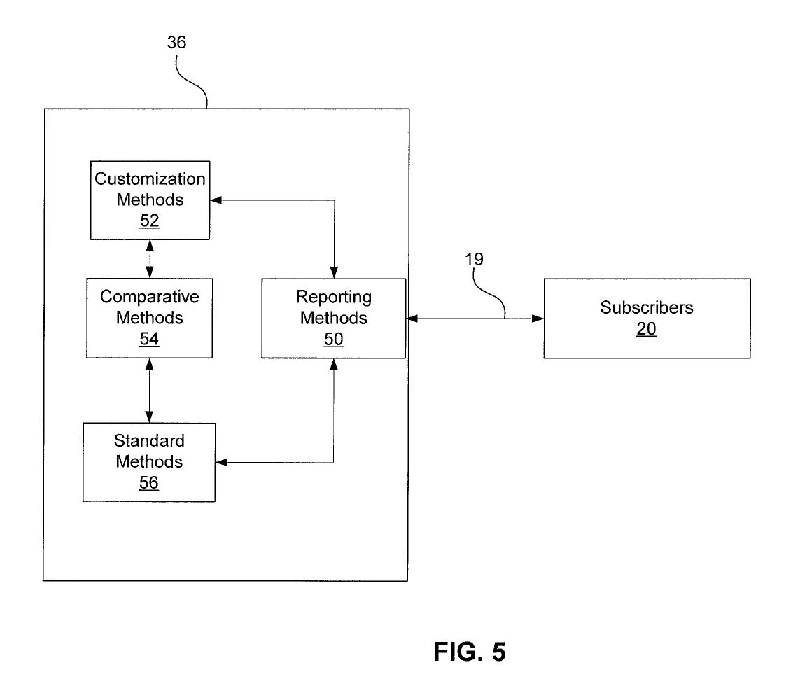

Turning to FIG. 5 a set of functional elements included within the subscriber interface 36 are illustratively depicted in accordance with an embodiment of the invention. The elements comprise, by way of example, a set of methods grouped according to their functionality. In general the subscribers 20 communicate with the index aggregator 10 via the network link 19 and the subscriber interface 36. The subscriber interface 36 receives data queries for calculated service indices rendered by the processing engine 38 of the index aggregator 10, and transfers responsive indices obtained from the index data store 32 to the subscribers 20. As shown in FIG. 5, primary functional elements of the interface 36 comprise reporting methods 50, customization methods 52, comparative methods 54, and standard methods 56.

The reporting methods 50 perform interface functions enabling the index aggregator 10 to receive and pass requests originating from subscribers 20 to an appropriate one of the customization methods 52, standard methods 56, and comparative methods 54. The reporting methods 52 receive responses from the customization methods 52, standard methods 56, and comparative methods 54 and passes that information to the appropriate ones of the requesting subscribers 20. Reporting channels via network link 60 include, but aren't limited to, telephone, print, electronic, fax, mail, email, etc. However, in a particular embodiment of the invention, the reporting methods 52 support index aggregator 10 interfaces to subscribers 20 via the Internet in the form of a Web site. The Web site supports subscriber queries for pre-calculated and customized index values.

Customization methods 52 facilitates specification, by subscribers 20, of a variety of service performance indices by specifying constituent components, filters specifying particular transactions and data types (e.g., channel, factor, sector, etc.), and the proper weights applied to components and/or the transaction data making up the components. For example, the customization tool allows a subscriber to modify a weighting of index components, sources, factors, and/or channels provided for a standard, pre-defined index. Thus, if a selected sector, such as government agencies, has a pre-defined index of twenty index components programmed into the index integrator 10, a subscriber can, via the customization tool, modify an index weighting that places greater scoring emphasis on components based on externally generated service data, such as benchmarking figures or customer satisfaction, versus components based upon internally generated service data, such as response time or response quality.

Customizing indices, in accordance with embodiments of the present invention, takes a variety of forms. Customization can go as far as creating entirely new indices from scratch. Alternatively, customization comprises taking one or more existing indices and specifying changes such as, for example, adding or removing components, specifying particular filters for transactions (e.g., channel, factor, volume), or applying weighting criteria to retrieved service data favoring specific industry sectors, service channels, service factors and/or service data sources.

On the other hand, standard methods 56 provide subscriber access via the reporting methods 50 to an enumerated set of pre-configured standard indices. For example, a pre-configured bank index includes a ready built index of banking index components with defined weights. As indicated by the line connecting the standard methods 56 to the customization methods 52, a user accesses for modification (via the customization methods 52) the set of standard index definitions provided by the standard methods 56. The actual execution of the index definitions occurs in the processing engine 38 described in detail hereinabove.

The comparative methods 54 facilitate subscribers 20 requesting presentation of multiple distinct indices. By way of example, such presentations enable subscribers to compare the performance of their own customer service facilities to a generalized index covering a relevant sector or even broader service performance index. Other comparisons comprise standard indices rendered via the standard methods 56 and customized indices rendered via the customization methods 52 and standard indices designated via the standard methods 56.

Rather than operating as a standalone set of operations, the comparative methods 54 rely upon the customization methods 52 and standard methods 54 for their input. The comparative methods 54 submit queries to, and receive output information from the standard methods 56 and customization methods 52. The comparative methods 54 take the output of the standard methods 56 and/or the customization methods 52 and render the information in a manner easily understood by a subscriber (e.g., a histogram, a bar chart, etc.). The display information is provided to the reporting methods 50 that convey the information to the subscribers 20. For example, a subscriber 20 requests via the comparative methods 54 a customized index, for a sector such as healthcare, versus a more generalized pre-programmed standard healthcare index. The comparative methods 54 submit appropriate queries to the customization methods 52 and the standard methods 56. The resulting data is organized and presented by the comparative methods 54 to the reporting methods 50. The reporting methods 50, by way of example, transmit the comparative data in the form of, for example, HTML commands causing a comparative chart to be displayed that represents the customized index and the pre-programmed standard index. The index value results potentially give a subscriber feedback for identifying service performance shortcomings and serving notice with regard to areas where improvement is needed. In yet another example, the comparative methods 54 enable a subscriber to request and receive presentation of a comparison between a set of service indices associated with distinct sectors, such as healthcare versus travel and foodservice sectors.

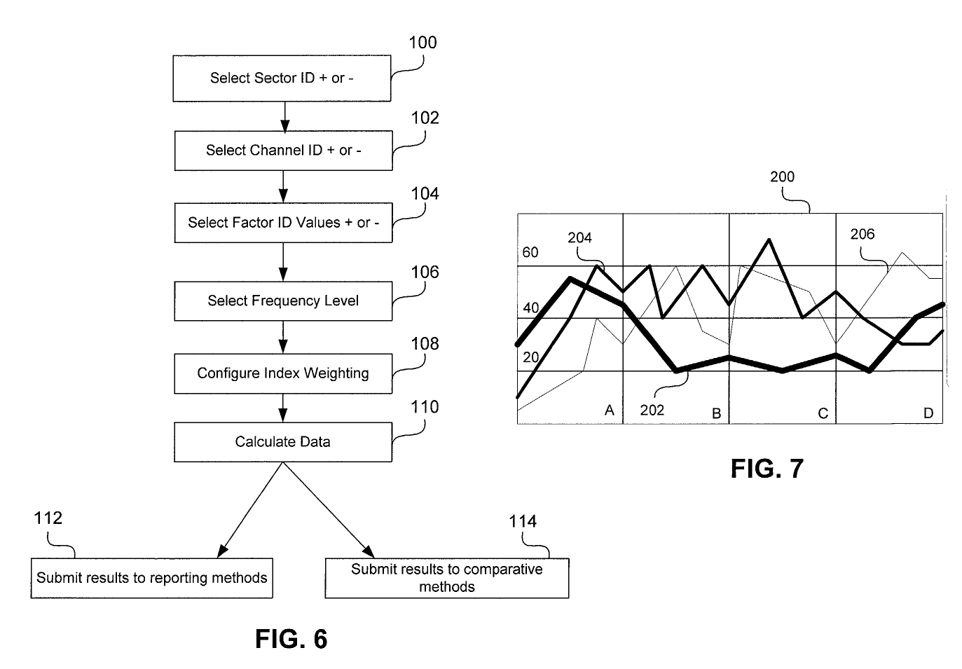

Turning to FIG. 6 a set of steps are summarized that represent an exemplary sequence of acts/operations performed in association with the customization methods 52. The customization methods 52 facilitate creation and/or modification of service performance index definitions. During step 100 a user, upon selecting a particular sector (including a null sector if the user wishes to start from scratch), is prompted to add/delete particular components (e.g., named service entities). In the case of additions, the user selects from a list of available components represented in the service performance data store 30. In the case where a user selects a particular sector, deletions are performed by reference to a list of displayed components of a sector selected by the user. During step 100, subscribers 20 configure customized index values by adding or deleting specific index components associated with an identified sector. For example, a standard index exists for a sector such as government agencies. Furthermore, the index comprises twenty index components. During step 100 a subscriber requests adds and/or deletes any number of index components or agency names to render a customized index including differing components.

Furthermore, additions are not limited to particular sectors corresponding to a particular selected index that is being modified. The customization methods 52 enable creating customized indexes by adding non-corresponding index components within a selected standard industry sector index. For example a selected ready-built banking index of twenty index components exists. A subscriber requests the customization methods 52 to add a non-corresponding financial institution, such as a mutual fund company, to the standard banking index. In yet another embodiment of the invention, multiple sector IDs are specified to render an index rendered from service transaction data for multiple sectors.

Next, at step 102 subscribers designate adding/deleting particular factors from a pre-existing index. For example, a subscriber through the customization methods 52 designates a set of channels such as fax, email, and telephone for the formulation of an index. Furthermore, the customization methods 52 during step 102 enable subscribers to quickly remove the telephone and email channel designations, and add postal mail and voice recognition systems as replacement service channels. Another customization method 52 enables users during step 104 to select particular factors to add and/or remove from calculation of an index by the processing engine 38. For example, a subscriber designated during step 104 a set of factors such as response quality, routing accuracy, and customer satisfaction. Furthermore, during step 104 customization methods 104 enable subscribers to quickly remove a previously designated response quality and routing accuracy factor from index calculations, and to add order processing and complaint management as replacement factor types represented in an index.

In accordance with another customization method, during step 106 a subscriber designates a transaction frequency filter for index components. The frequency testing level selection enables subscribers to customize an index to limit input to index calculations based upon the volume of service transactions. For example, a first group of automobile dealers may have a higher frequency of service transactions in comparison to a second group of automobile dealers. During step 106 a user specifies a frequency property and thereby allows the dealer groups to create indices that more closely track their operations with regard to the frequency of service transactions. A dealer with high transaction volume generally selects a high frequency filter level, whereas a dealer with low transaction volume likely selects a low frequency filter level. The frequency values are specified in a variety of forms. However, in each instance, the frequency values correspond to a number of transactions that are executed by a service rendering entity over a period of time.

During step 108, the customization methods 52 enable users to specify particular weighting criteria to input elements (e.g., components, channels, factors, etc.) that go into the processing engine 38's calculation of indices. By way of example, an index comprising components from the government agencies sector has a ready built index of twenty index components including both internal and external data. Rather than giving each component equal weight, a subscriber, during step 108, specifies an index weighting scheme that places greater weight on externally generated service data, such as benchmark figures or customer satisfaction provided by a third party data provider, than internally generated service data, such as response time or response quality as measured under the direction or control of the service quality data aggregation and indexing system. In yet other examples customized indexes are generated based upon weights to particular sectors, service channels, service factor types, and/or service data sources.

During step 110 the customization methods 52 pass a set of index computation parameters to the processing engine 38. Upon receiving a computed index value (or set of values), the customization methods 52 pass the results to either the reporting methods 50 during step 112 or alternatively the comparative methods 54 according to step 114.

Turning to FIG. 7 an exemplary histogram chart depicts a set of service performance indices specified via the comparative methods 54. Subscribers 20 submit data queries to the comparative methods 54 requesting display of specified indices during a period of time. FIG. 7 is a sample scenario of resulting output. Comparative methods 54 communicate with standard methods 56 and customization methods 52 to determine/establish a set of specified indices to be rendered and displayed. The comparative methods 54 establish an index performance histogram 200. A left edge includes a scale representing a range of index values. A bottom edge represents a time span.

By way of example, to compare the routing accuracy performance of three separate indices on one service channel (e.g., on-line via the Internet) the comparative methods 54 establish a scale wherein a score of “20” is failing, an index score of “40” is average, and “60” corresponds to superior service. Next, calculated values for the three distinct indices are specified for the graph and are displayed as lines 202, 204, and 206. The graphic display of the indices, provided to subscribers via the reporting methods 50, facilitates quick, streamlined review of service performance by subscribers 20.

Numerous modifications and alternative embodiments of the invention will be apparent to those skilled in the art in view of the forgoing description. Accordingly, this description is to be construed as illustrative only and is for the purpose of teaching those skilled in the art the best mode as well as exemplary alternative ways to carry out the invention. Details of the structure for carrying out the present invention will vary substantially without departing from the spirit of the invention and the exclusive use of all modifications, which come within the scope of the appended claim, is reserved.

What is claimed is:

1. A system for computing indices representing quality of service rendered via multiple communication channels, wherein the quality of service indices comprise multiple components, and wherein values assigned to ones of the multiple components are based upon quality of service data potentially received from multiple service data sources, the system comprising:
a quality of service data input interface that receives quality of service data, the quality of service data comprising service transaction records, each service transaction record including a source ID identifying a service rendering entity, a channel ID identifying a communications channel associated with a rendered service transaction, and at least one factor value associated with the rendered service transaction;
a raw service data store comprising one or more tables for storing the received quality of service data; and
an index aggregator for computing a service index based upon the quality of service data maintained by the raw service data store and an index definition, and wherein the index definition specifies a set of index components and a component weighting definition.

2. The system of claim 1 further comprising a subscriber interface enabling users to specify a service transaction index to be reported by the index aggregator.

3. The system of claim 2 wherein the subscriber interface includes a customization component enabling a user to specify a customized index including a set of component data definitions differing from a pre-programmed index.

4. The system of claim 3 wherein the specified set of component data definitions includes a specified sector filter.

5. The system of claim 3 wherein the specified set of component data definitions includes a specified channel filter.

6. The system of claim 3 wherein the specified set of component data definitions includes a specified factor filter.

7. The system of claim 3 wherein the specified set of component data definitions includes a specified transaction frequency filter.

8. The system of claim 2 wherein the subscriber interface includes a customization component enabling a user to define a customized index including a component weighting definition differing from a pre-programmed index.

9. The system of claim 8 wherein the component weighting definition includes applying differing weight to service transaction data associated with particular channels.

10. The system of claim 8 wherein the component weighting definition includes applying weights to data in the service transaction records based upon specified factor value types.

11. The system of claim 1 wherein the set of index components comprise both internal and external index components.

12. The system of claim 11 wherein at least one of the external index components is based upon summary quality of service data received from a data source.

13. The system of claim 1 wherein quality of service data transaction records include individual service transactions.

14. The system of claim 1 wherein quality of service data transaction records include summary records representing aggregated data from multiple service transactions.

15. The system of claim 2 wherein the subscriber interface includes a set of comparative methods that, in association with reporting methods, displays two or more rendered indices to facilitate comparison by subscribers.

16. A method for generating, by a system, indices representing quality of service rendered via multiple communication channels, wherein the quality of service indices comprise multiple components, and wherein values assigned to ones of the multiple components are based upon quality of service data potentially received from multiple service data sources, the method comprising the steps of:
receiving, by a quality of service data input interface, quality of service data, the quality of service data comprising service transaction records, each service transaction record including a source ID identifying a service rendering entity, a channel ID identifying a communications channel associated with a rendered service transaction, and at least one factor value associated with the rendered service transaction;
storing, by a raw service data store comprising one or more tables, the received quality of service data; and
computing, by an index aggregator, a service index based upon the quality of service data maintained by the raw service data store and an index definition, and wherein the index definition specifies a set of index components and a component weighting definition.

17. The method of claim 16 further comprising, specifying via a subscriber interface, a service transaction index to be reported by the index aggregator.

18. The method of claim 17 wherein the subscriber interface includes a customization component enabling a user to specify a customized index including a set of component data definitions differing from a pre-programmed index.

19. The method of claim 17 wherein the subscriber interface includes a customization component enabling a user to define a customized index including a component weighting definition differing from a pre-programmed index.

20. The method of claim 16 wherein the set of index components comprise both internal and external index components.
